(19) United States
(12) Patent Application Publication
(10) Pub. No.: US 2008/0036337 A1
(43) Pub. Date: Feb. 14, 2008

(54) Fan and motor thereof

(75) Inventors: Chen-Mo Jiang, Taoyuan Hsien (TW); Chung-Kai Lan, Taoyuan Hsien (TW); Hung-Chi Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/882,540

(22) Filed: Aug. 2, 2007

(30) Foreign Application Priority Data
Aug. 14, 2006 (TW) 095129724

(51) Int. Cl. H02K 7/14; H02K 11/00; H02K 5/00

(52) U.S. Cl. 310/68 R; 310/89

(57) ABSTRACT

A fan and a motor thereof are disclosed. The motor includes a first module, a rotor assembly and a second module. The first module includes a housing and a stator assembly disposed within the housing. The rotor assembly includes a shaft and a magnetic element which mounts the shaft and is disposed corresponding to the stator assembly. The second module includes a base and a driving element disposed on the base and electrically connected with the stator assembly through a conducting structure. When the housing and the base are assembled, a space is obtained for accommodating the rotor assembly therein, and the shaft protrudes from the housing.

### CROSS REFERENCE TO RELATED APPLICATIONS

This Non-provisional application claims priority under 35 U.S.C. §119(a) on Patent Application No(s). 095129724, filed in Taiwan, Republic of China on Aug. 14, 2006, the entire contents of which are hereby incorporated by reference.

### BACKGROUND OF THE INVENTION

1. Field of Invention

The invention relates to a fan and the motor thereof, and particularly the invention relates to a fan and an inner-rotor motor thereof.

2. Related Art

A motor is a device that converts electrical energy into mechanical energy, and therefore the motor has been widely used in common mechanical structures. Although there are many different kinds of motors, they can be roughly divided into two types: inner-rotor motors and outer-rotor motors. The major difference between them is whether the rotor rotates internally or externally.

As shown in FIG. 1, a conventional brushless motor 1 is used to drive the impeller of a fan to rotate. The brushless motor 1 includes a bearing base 10, a rotor structure 12, and a circuit board 13. The rotor structure 11 includes a shaft 111 and a magnetic element 112. The shaft is 111 pivotally mounted on the bearing base 10. The stator structure 12 includes several coil sets 121 disposed corresponding to the magnetic element 112. The circuit board 13 is disposed on the bearing base 10. The coil set 121 of the stator structure 12 is electrically connected to the connecting points on the circuit board 13 by soldering. The circuit board 13 controls the current direction in the coil sets 121, generating a magnetic field that interacts with the magnetic element 112 of the rotor structure 11 to allow the rotor structure 11 to rotate. However, the stator structure 12 and the circuit board 13 have to be connected by soldering which causes an increase in the production cost. Also, once the coil sets 121 or the circuit board 13 is damaged and needs a replacement, it is difficult to separate them, thereby making the maintenance relatively nontrivial.

Further, the brushless motor 1 involves the combination of many components. A gap G easily exists between the rotor structure 11 and the circuit board 13. Therefore, impurities or moisture may enter the motor structure via the gap G. This can damage and affect the component functions, reducing the reliability and lifetime of the motor.

### SUMMARY OF THE INVENTION

In view of the foregoing, the invention is to provide a fan and a motor thereof involving simplified assembly and maintenance, thereby reducing the assembly and maintenance time and increasing the reliability and sealing property for the purposes of protecting of its components and elongating its lifetime.

To achieve the above, the invention discloses a motor including a first module, a rotor assembly and a second module. The first module includes a housing and a stator assembly disposed inside the housing. The rotor assembly includes a shaft and a magnetic element which mounts the shaft and is disposed corresponding to the stator assembly. The second module includes a base and a driving element disposed inside the base and electrically connected to the stator assembly. When the housing and the base are assembled, the rotor assembly is accommodated within a space obtained between the housing and the base. The shaft protrudes from the housing. Also, there is at least one dissipating hole at the housing or the base for dissipating heat during operation of the motor.

To achieve the above, the invention also discloses a fan including a motor and an impeller. The motor includes a first module, a rotor assembly and a second module. The first module has a housing and a stator assembly disposed inside the housing. The rotor assembly has a shaft and a magnetic element which mounts the shaft and is disposed corresponding to the stator assembly. The second module has a base and a driving element disposed inside the base and electrically connected to the stator assembly. When the housing and the base are assembled, the rotor assembly is accommodated within a space obtained between the housing and the base. The shaft protrudes from the housing, and the impeller connected to the shaft. Also, there is at least one dissipating hole at the housing or the base for dissipating heat during operation of the motor.

The fan and motor of the present invention further includes at least one conductive structure electrically connecting the stator assembly and the driving element. The conductive structure has at least one first conductive element and at least one second conductive element, both of which are disposed correspondingly and in direct contact to form an electrical connection. The first conductive element is disposed on the stator assembly and the second conductive element is disposed on the driving element, and the stator assembly and the driving element are electrically connected via the first conductive element and the second conductive element. The first conductive element is a metal plate or a metal rod and the second conductive element is correspondingly a holding plate or a recess, and vice versa. Alternatively, the conductive structure is a soft conductor, or a wire, electrically connecting the stator assembly and the driving element by soldering, thereby allowing the stator assembly and the driving element to be electrically connected.

As mentioned above, the fan and the motor of the present invention integrate and modulize several components. As the result, the total number of components can be significantly reduced. Also, the connection of the housing and the base provides an accommodation space with a good sealing property to enclose the stator assembly, rotor assembly, and driving element, whereby preventing them from impurities or moisture. Compared with the prior art, the motor of the present invention provides a good protection for all components so as to increase product reliability and lifetime. Also, the motor of the present invention simplifies the assembly and maintenance procedures, thereby reducing the assembly time.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional brushless motor;

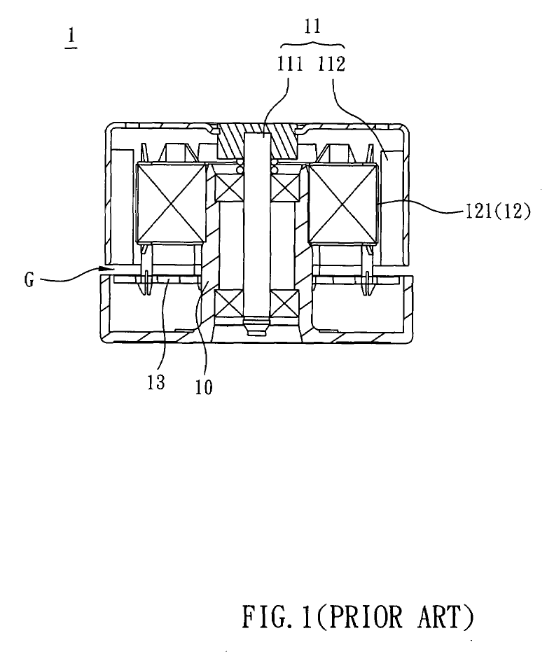

FIG. 2 is an exploded view of the disclosed motor according to the preferred embodiment of the present invention;

FIG. 3 is a cross-sectional view of the assembled motor in FIG. 2;

FIG. 4 is a schematic view of the base and the second conductive elements thereon in FIG. 2; and

FIG. 5 is a schematic view of the fan according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

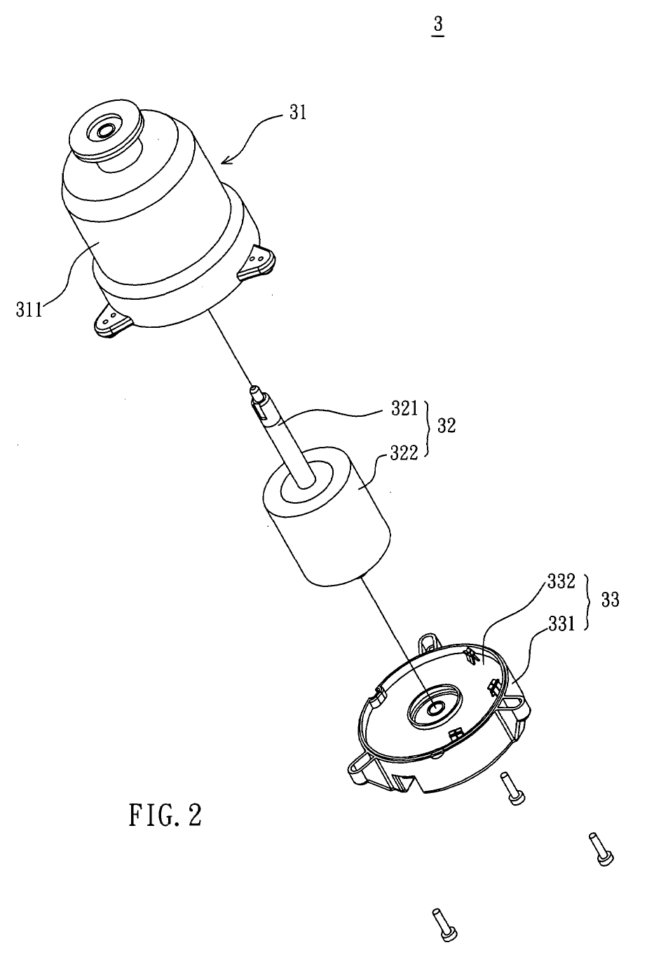

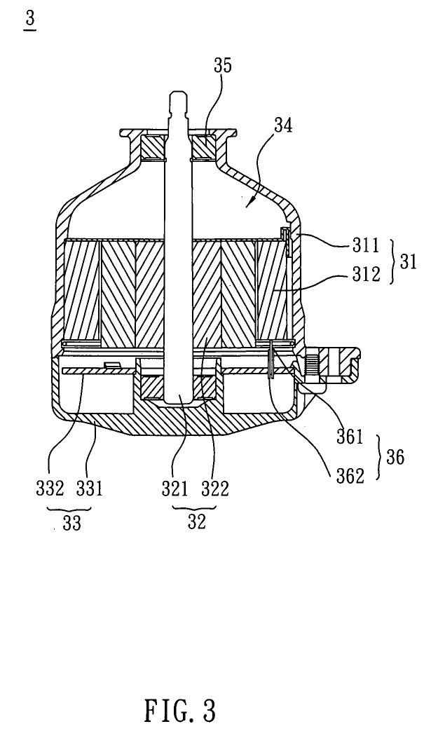

As shown in FIGS. 2 and 3, the motor 3 according the preferred embodiment of the present invention includes a first module 31, a rotor assembly 32, and a second module 33.

The first module 31 includes a housing 311 and a stator assembly 312. The stator assembly 312 is disposed inside the housing 311 so as to be integrated as a single module. The stator assembly 312 has a magnetic conductive element disposed around the inner wall of the housing 311. In this embodiment, the magnetic conductive element includes at least one silicon steel plate and at least one coil winding around the silicon steel plate (not shown).

The rotor assembly 32 includes a shaft 321 and a magnetic element 322. The magnetic element 322 mounts the shaft 321 and is disposed corresponding to the stator assembly 312. In particular, the magnetic element 322 is a permanent magnet.

The second module 33 includes a base 331 (or a shell) and a driving element 332. The driving element 332 is disposed inside the base 331 so as to be integrated as a single module. In this embodiment, the driving element 332 has a circuit board with several electronic elements disposed thereon. In order to protect the electronic elements, the surface of the circuit board disposed with the electronic elements is located and faces the inner surface of the base 331, and then the base 331 and the driving element 332 are modulized. In addition, the circuit board can be further coated with an insulating gel before the modulization.

As shown in FIG. 3, the housing 311 and the base 331 are assembled in such a way and an accommodation space 34 is obtained therebetween. The stator assembly 312, the rotor assembly 32, and the driving element 332 are disposed in the accommodation space 34. The shaft 321 of the rotor assembly 32 protrudes from the housing 311 and a part of the shaft 321 is exposed. The protruding part can be used to connect other components. The motor 3 in this embodiment further includes at least one bearing 35 mounting the shaft 321, and the bearing 35 is used to support the shaft 321 during the operation of the motor 3. The material of the housing 311 or the base 331 is a metal or plastic. Also, there is at least one dissipating hole (not shown) at the housing 311 or the base 331 for dissipating heat during operation of the motor 3.

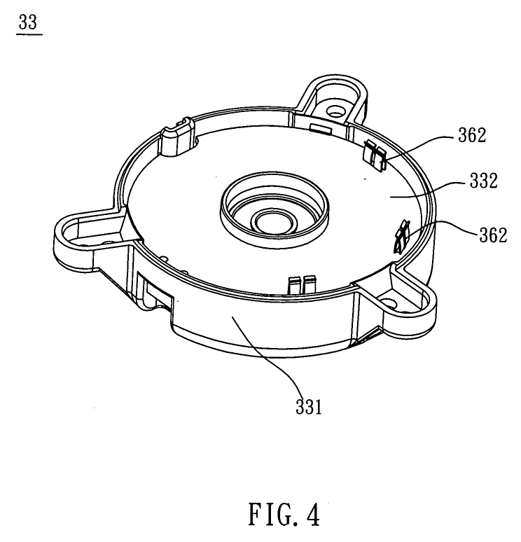

The driving element 332 and the stator assembly 312 are electrically connected. In this embodiment, the motor 3 further includes at least one conductive structure 36 for electrically connecting the stator assembly 312 and the driving element 332. The driving element 332 controls the stator assembly 312 to generate a magnetic interaction with the rotor assembly 32, thereby driving the rotor assembly 32 to rotate. In this embodiment, the conductive structure 36 has at least a first conductive element 361 and at least a second conductive element 362. The first conductive element 361 and the second conductive element 362 are disposed correspondingly and in touch with each other, thereby providing an electrical connection. Please refer to FIGS. 3 and 4. FIG. 4 is a schematic view of the base and the second conductive element thereon in FIG. 2. The first conductive element 361 is a metal plate or a metal rod disposed on the stator assembly 312, and the second conductive element 362 is a holding plate or a recess formed in the driving element 332 correspondingly. By the holding plate clips and touches the metal plate, the electrical connection between the stator assembly 312 and the driving element 332 is achieved, i.e. by using a direct physical contact way. It is noted that the number and positions of the first conductive elements 361 and the second conductive elements 362 are not limited thereto, as long as the first conductive elements 361 and the second conductive elements are disposed in a corresponding way and in contact with each other so as to provide an electrical connection. In addition to the above configuration, the second conductive element 362 can be a metal plate or a metal rod, and the first conductive element can be a holding plate or a recess as well.

Alternatively, the conductive structure 36 can be a soft conductor or a wire, in addition to the above-mentioned direct contact between the two conductive elements. The conductive structure 36 is connected to the stator assembly 312 and the driving element 332 by soldering, and therefore the stator assembly 312 and the driving element 332 are electrically connected.

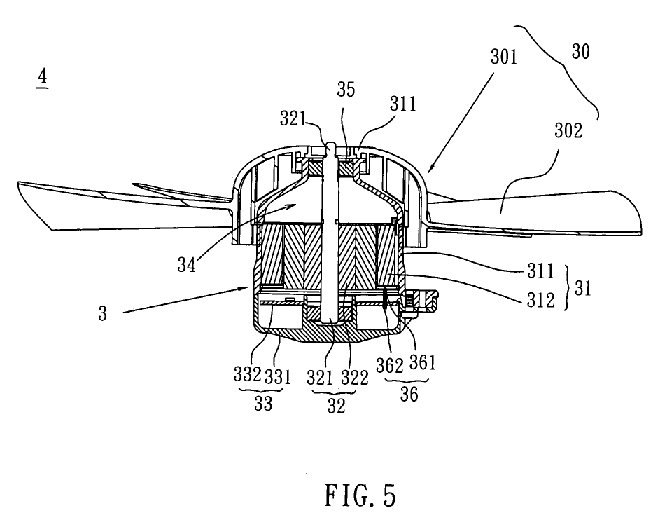

As shown in FIG. 5, the fan 4 according to the preferred embodiment of the prevent invention includes a motor 3 and an impeller 30. The fan 4 in this embodiment is a vehicle fan, particularly is using for the cooling tank of a vehicle. However, the invention is not to be restricted by this example. The motor 3 has been described before, so the detailed descriptions thereof are omitted.

The impeller 30 includes a hub 301 and several blades 302 disposed around the hub 301. The hub 301 is connected to the part of the shaft 321 that protrudes the impeller 30 to rotate and generate airflow for heat dissipation.

In summary, the fan and the motor of the present invention integrate and modulize several components. As the result, the total number of components can be significantly reduced. Also, the connection of the housing and the base provides an accommodation space with a good sealing property to enclose the stator assembly, rotor assembly, and driving element, whereby preventing them from impurities or moisture. Compared with the prior art, the motor of the present invention provides a good protection for all components so as to increase product reliability and lifetime. Also, the motor of the present invention simplifies the assembly and maintenance procedures, thereby reducing the assembly time.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A motor, comprising:
a first module comprising a housing and a stator assembly disposed inside the housing;
a rotor assembly comprising a shaft and a magnetic element, the magnetic element mounting the shaft and being disposed corresponding to the stator assembly; and
a second module comprising a base and a driving element disposed inside the base and electrically connected to the stator assembly, wherein the housing and the base are connected for accommodating the rotor assembly, and the shaft protrudes from the housing.

2. The motor of claim 1, further comprising at least one conductive structure, which electrically connects the stator assembly and the driving element.

3. The motor of claim 2, wherein the conductive structure has at least one first conductive element and at least one second conductive element, both of which are disposed correspondingly and in direct contact to form an electrical connection.

4. The motor of claim 3, wherein the first conductive element is disposed on the stator assembly and the second conductive element is disposed on the driving element, so that the stator assembly and the driving element are electrically connected via the first conductive element and the second conductive element.

5. The motor of claim 3, wherein the first conductive element is a metal plate or a metal rod and the second conductive element is a holding plate or a recess correspondingly, and vice versa.

6. The motor of claim 2, wherein the conductive structure is a soft conductor or a wire which allows the stator assembly and the driving element to be electrically connected.

7. The motor of claim 1, wherein the driving element has a circuit board, and the circuit board has a plurality of electronic elements disposed on a surface of the circuit board that faces an inner surface of the base.

8. The motor of claim 1, further comprising at least one bearing mounting the shaft.

9. The motor of claim 1, wherein a material of the housing or the base comprises metal or plastic.

10. The motor of claim 1, wherein there is at least one dissipating hole at the housing or the base for dissipating heat during operation of the motor.

11. A fan, comprising:
a motor comprising a first module, a rotor assembly and a second module, wherein the first module has a housing and a stator assembly disposed inside the housing, the rotor assembly has a shaft and a magnetic element which mounts the shaft and is disposed corresponding to the stator assembly, the second module has a base and a driving element disposed inside the base and electrically connected to the stator assembly, the housing and the base are connected for accommodating the rotor assembly, and the shaft protrudes from the housing; and
an impeller connected to the shaft.

12. The fan of claim 11, wherein the motor further comprises at least one conductive structure which electrically connects the stator assembly and the driving element.

13. The fan of claim 12, wherein the conductive structure has at least one first conductive element and at least one second conductive element, both of which are disposed correspondingly and in direct contact to form an electrical connection.

14. The fan of claim 13, wherein the first conductive element is disposed on the stator assembly and the second conductive element is disposed on the driving element, so that the stator assembly and the driving element are electrically connected via the first conductive element and the second conductive element.

15. The fan of claim 13, wherein the first conductive element is a metal plate or a metal rod and the second conductive element is a holding plate or a recess correspondingly, and vice versa.

16. The fan of claim 12, wherein the conductive structure is a soft conductor or a wire which allows the stator assembly and the driving element to be electrically connected.

17. The fan of claim 11, wherein the driving element has a circuit board, and the circuit board has a plurality of electronic elements disposed on a surface of the circuit board that faces an inner surface of the base.

18. The fan of claim 11, wherein the motor further comprises at least one bearing mounting the shaft.

19. The fan of claim 11, wherein a material of the housing or the base comprises metal or plastic.

20. The fan of claim 11, wherein there is at least one dissipating hole at the housing or the base for dissipating heat during operation of the motor.
